(19) United States
(12) Patent Application Publication
(10) Pub. No.: US 2007/0254261 A1
(43) Pub. Date: Nov. 1, 2007

(54) Wireless control for dental equipment

(75) Inventors: Kenneth Rosenblood, Los Angeles, CA (US); Haim Levy, Hod Hasaron (IL); Ben Atkin, North Miami, FL (US); Nancy N. Quan, North Hills, CA (US)

Correspondence Address: DISCUS DENTAL IMPRESSIONS, INC., 8550 HIGUERA STREET, CULVER CITY, CA, 90232, US

(73) Assignee: Discus Dental Impressions, Inc., Culver City, CA (US)

(21) Appl. No.: 11/417,284

(22) Filed: Apr. 26, 2006

(51) Int. Cl. A61C 1/02

(52) U.S. Cl. 433/98

(57) ABSTRACT

The present invention relates to a wireless remote control for dental equipment, such as dental scaler tools, dental drills, prophy angles and other rotary instruments. The wireless control switch can control the on and off state of the dental tool, or it can also be programmed to control the speed of the tool by a switch on the tool. The wireless control switch can be in the form of, for example, a foot switch, and replaces manual and foot operated controls formerly connected by cables to the dental tools. This removes a potential safety hazard in the dentist's office and makes the equipment control more versatile and easier to adapt to various office conditions. The wireless control can be battery powered, further eliminating the need for cables.

### CROSS-REFERENCE TO RELATED APPLICATIONS

The present application is the National Stage of International Application No. PCT/US2004/039937 designating the United States, filed on Nov. 24, 2004, which claims the benefit under 35 U.S.C. 119(e) of U.S. Provisional Patent Application No. 60/524,911, filed on Nov. 26, 2003, the disclosures of which are herewith incorporated by reference in their entirety.

### FIELD OF THE INVENTION

The present invention relates to dental instruments and more particularly to control devices for dental instruments.

### BACKGROUND OF THE INVENTION

Many tools are operated by electrical power in a dentist's office. Unless they are battery powered, such tools are tethered and connected to the electrical source by cables. Since most power inlets are installed around the walls of a dentist's office, such cables traverse the room where dental procedures are performed. Some tools are operated by manual foot pedals, which are also connected by cables to the power source. The cables can be a potential hazard to both the dental professional and patient.

In addition, the complexity and clutter tends to reduce the efficiency of dental procedures by slowing the activities of the dental professional. Complexity and clutter in the environment also increases the risk of error and accident. Thus, there remains a need for another means of control that can reduce complexity and clutter in the working environment of the dental professional and minimize potential hazards.

### SUMMARY OF THE INVENTION

The present invention relates to a wireless remote control for dental equipment, such as dental scaler tools, dental drills, prophy angles, rotary instruments.

In an exemplary embodiment of the present invention, a wireless control such as a foot pedal is used to control the operation of an ultrasonic dental tool comprising a base unit, a handpiece comprising a handle and an insert, and a wireless control switch such as a foot switch. The handpiece is coupled at one end (i.e., the proximal end) to an electrical energy source, a fluid source and/or gas, via a cable. The cable includes a hose to provide a fluid (e.g., water), and/or a gas, and conductors to provide electrical energy. The other end (i.e., the distal end) of the handpiece has an opening intended to receive an insert with a transducer (e.g., a magnetostrictive transducer) carried on the insert. The transducer extends from the proximal end of the insert into a hollow interior of the handpiece. An ultrasonically vibrated tip extends from a distal end of the insert. The handle has means therein which is adapted to impart a vibration to the insert. Such means are well known in the art and may be mechanical, magnetostrictive or piezoelectric in nature. The dental tool described can be in the form of a dental scaler.

When the wireless control is a foot switch, depressing the foot switch will result in activation of the ultrasonic handpiece and also delivery of cooling water to the insert tip. When the foot is removed from the foot control, both the ultrasonic handpiece and water are shut off.

The wireless control, such as the foot switch, replaces manual and foot operated controls formerly connected by cables to the dental tool and/or to the power supply. This removes a potential safety hazard in the dentist's office and makes the equipment control more versatile and easier to adapt to various office conditions.

In another exemplary embodiment of the invention, the dental tool comprises a base unit, a handpiece comprising a handle, a dental insert and a wireless control switch such as a foot switch. The dental tool is connected to a power, and/or fluid, and/or an air supply source through a conduit cable, so that the supply source, though coupled to the tool, is located at a position remote from the working end of the tool. The wireless foot switch, in the form of such as a pedal, is located within easy reach of the operator to permit turn-on and/or turn-off of the tool. The signaling means which simply and yet effectively provides for selective automatic turn on and turn off of the tool while totally eliminating the need for an electrical connection between the main supply unit and the remote control unit again removes a potential safety hazard in the dentist's office and makes the equipment control more versatile and easier to adapt to various office conditions. In addition to controlling the on and off of the dental tool, the wireless module can also be programmed to control the speed of the tool by a switch on the tool.

The dental tool includes a dental drill, a rotary instrument, an endodontic file and a prophy angle. A common or different handpiece can be used with various inserts to form these tools. For example, a dental drill comprises a drill bit; a rotary tool comprises an insert, such as a multi-use diamond dental bur; a dental carbide bur; a dental sintered diamond bur; a dental diamond disc; a dental laboratory tungsten carbide cutter; a steel dental bur; an endodontic file; and a prophy angle comprising a longitudinal body and a prophy cup. The insert comprises a shank or attachment adapted to be fitted into the handpiece.

In addition to having wireless control in a dental office, a still further embodiment of the invention comprises a wireless control such as a foot switch for use with, especially rotary dental instruments or drills, in a dental laboratory. A dental drill or a rotary dental tool such as a carbide bur, is connected to a power supply through a conduit cable so that the power supply source, though again coupled to the handpiece, is located at a position remote from the working end of the handpiece. The wireless control in the form of such as a foot pedal is located within easy reach of the operator to permit turn-on and/or turn-off of the instrument, thus again eliminating the need for an electrical connection between the main power supply unit and the remote control unit. This removes a potential safety hazard in a dental laboratory and makes the equipment control more versatile and easier to adapt to various laboratory conditions.

In still a further aspect of the present invention, the above exemplary dental tools can also be fitted with at least one light source. The light source can draw its power supply from the same or different power source that supplies the power for the operations of the tool, or the light source can draw its power from the energy created by the ultrasonic vibrations. A wireless control means for the selective energizing of the light supply source can be separate or the same as the wireless means that controls the on and off of the dental tool. If a separate control is used, it can also be located within easy reach of the operator to permit turn-on and/or turn-off of the light supply source through simple foot pedal control provided within a remote control unit

These and other advantages and features of the invention will be more readily understood in relation to the following detailed description of the invention, which is provided in conjunction with the accompanying drawings.

### BRIEF DESCRIPTION OF THE DRAWINGS

FIG. 1 shows an ultrasonic dental instrument according to one embodiment of the invention including a handpiece and a wireless foot pedal;

FIG. 2 shows a rotary dental instrument according to one embodiment of the invention including a handpiece and a wireless foot pedal;

FIG. 3 shows a perspective view of a dental instrument, including a supply apparatus and a foot-pedal device, according to one embodiment of the invention;

FIGS. 4a and 4b show dental burs for use in a wirelessly controlled dental instrument according to one embodiment of the invention; and

FIG. 5 shows an abrasive disk for use in a wirelessly controlled dental instrument according to one embodiment of the invention;

FIG. 6 shows a dental file according to one embodiment of the invention;

FIG. 7 shows a dental prophy angle attachment according to one embodiment of the invention;

FIG. 8 shows aspects of a wireless control transmitter in block diagram form according to one embodiment of the invention;

FIG. 9 shows aspects of a wireless control receiver in block diagram form according to one embodiment of the invention;

FIG. 10 shows a transmitter for an energy-efficient wireless control system according to one embodiment of the invention;

FIG. 11 shows a receiver for an energy-efficient wireless control system according to one embodiment of the invention;

FIG. 12 shows a transmitter for an analog wireless control system according to one embodiment of the invention;

FIG. 13 shows a transmitter for an analog wireless control system according to another embodiment of the invention;

FIG. 14 shows a transmitter for a digital wireless control system according to a further embodiment of the invention;

FIG. 15 shows a foot pedal device including a rotary digital encoder according to one embodiment of the invention;

FIG. 16 shows a foot pedal device including a linear digital encoder according to one embodiment of the invention;

FIG. 17 shows a transmitter for a wireless control system including a microprocessor device according to one embodiment of the invention;

FIG. 18 shows a receiver for a digital wireless control system according to one embodiment of the invention;

FIG. 19 shows a receiver for a wireless control system according to one embodiment of the invention;

FIG. 20 shows a receiver for a wireless control system according to a further embodiment of the invention;

FIG. 21 shows a further receiver for a wireless control system according to another embodiment of the invention;

FIG. 22 shows another receiver for a wireless control system according to still another embodiment of the invention;

FIG. 23 shows another receiver, including a microprocessor, for a dental instrument wireless control system.

### DETAILED DESCRIPTION OF THE INVENTION

Conventional ultrasonic units have a footswitch connected to the unit with a cable. When the foot control is depressed, a solenoid valve is activated permitting the flow of water and electricity through the regulator and through the solenoid, to the handpiece and over the dental insert or tip. Vibration of the insert is thus initiated by energizing the ultrasonic generation mechanism.

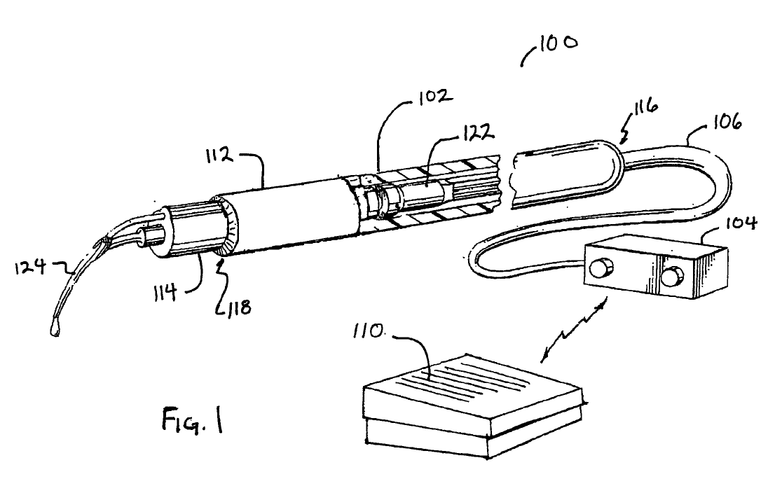

FIG. 1 illustrates an embodiment of the present invention in the form of an ultrasonic dental system 100 including an ultrasonic dental tool 102 attached to an electrical energy & fluid source 104, via a cable 106 along with a wireless control switch, shown here as a wireless foot pedal 110, conveniently disposed within easy reach by the dental professional. The cable 106 includes a conduit for carrying fluid as well as wires for carrying electrical power and signals from the electrical energy and fluid source 104 to the ultrasonic dental tool 102. The ultrasonic dental tool 102 includes a handpiece 112 and an insert 114 inserted into the handpiece 112. The activation of the electrical energy and fluid source control is carried out by means of the wireless foot pedal 110 located within communication range of the wireless control. The wireless foot pedal 110 is also located within easy reach by the dental professional.

In a preferred embodiment, the handpiece 112 is coupled at one end (i.e., a proximal end 116) to an electrical energy and fluid source 104 via a cable 106. The other end (i.e., a distal end 118) of the handpiece has an opening intended to receive therein an insert 114 with a transducer 122 which is adapted to impart a vibration to a tip of the insert 124. The transducer 122 may be, for example, mechanical, magnetostrictive or piezoelectric in nature. The transducer 122 extends from an aperture at the distal end 118 of the handpiece 112 into a hollow interior of the handpiece. An ultrasonically vibrated tip 124 extends from a distal end of the insert. In one exemplary embodiment, the insert 114 is a dental scaler.

In use, a dental practitioner touches a tip of the scaler lightly against a tooth. The transducer 122 imparts a vibratory motion to the tip of the scaler. The energy of this vibratory motion, is mechanically coupled to the tooth and plaque and calculus are consequently removed from the tooth.

According to one embodiment of the invention, depressing the foot pedal 110 results in activation of the ultrasonic transducer 122, and also in the delivery of cooling water to the insert tip. In one embodiment, when the foot pedal 110 is released, both the ultrasonic handpiece and water are shut off.

The absence of wires coupled between the foot pedal 110 and the electrical energy and fluid source 104 obviates a potential safety hazard in the dentist's office or dental laboratory and makes the equipment control more versatile and easier to adapt to various office conditions. This type of control can be adapted to control the speed of a device, such as a dentist's drill, or a rotary instrument, as shown and described in more detail below.

The ultrasonic insert can be made of metal, plastic or metallic alloys. Suitable metals or metallic alloys include stainless steel, titanium, titanium alloys such as nickel-titanium and titanium-aluminum-vanadium alloys; aluminum and aluminum alloys; and combinations thereof. The preferred materials are stainless steel and titanium alloys. Suitable plastics include high temperature plastics such as ULTEM®, which is an amorphous thermoplastic polyetherimide or Xenoy® resin, which is a composite of polycarbonate and polybutyleneterephthalate or Lexan® plastic, which is a copolymer of polycarbonate and isophthalate terephthalate resorcinol resin, all available from GE Plastics, or any other suitable resin plastic or composite. In general, the metal tips can be used for general cleaning, scaling and the like, while the non-metal tips may be used around sensitive gum lines, on expensive restorations such as crowns, bridges, and/or around titanium implants which may be more easily damaged by a metal tip.

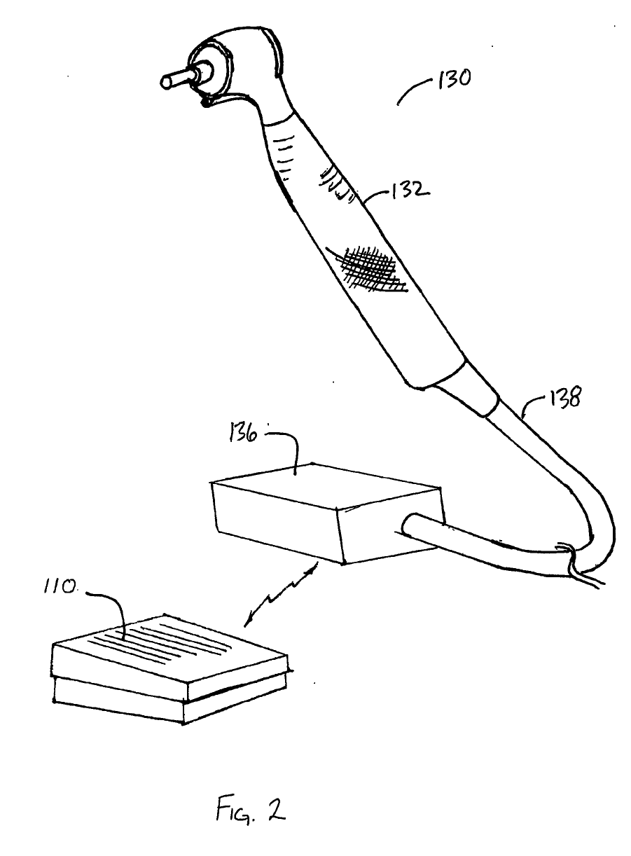

In addition to being an ultrasonic scaler, the dental instrument can also be of a non-ultrasonic type, such as a vibratory type, which utilizes a different handpiece from the ultrasonic handpiece described above in FIG. 1. The handpiece can be a handpiece used in dental drills and rotary instruments as shown, for example, in FIG. 2 below. Thus, the insert can also be in the form of an endodontic dental file, a drill, prophy angles or other instruments useful in the dental examination room or dental laboratory.

Although conventional dental drills, dental files, prophy angles and rotary instruments are not normally fitted with a foot switch, such instruments are also amenable to having a wireless switch for turning the instrument on and off, or to vary the speed of operation, as noted above. Thus, in another exemplary embodiment of the invention, a dental tool 130 as shown in FIG. 2, includes a handpiece 132 which is different from an ultrasonic handpiece as shown in FIG. 1. The dental tool also includes a wireless foot switch 110. The dental instrument is also connected to an air, water and power supply source 136 through a conduit cable 138, so that the supply source 136, though coupled to the handpiece, is located at a position remote from the working end of the handpiece 132.

The wireless foot switch 110 is again located within easy reach of the operator to permit turn-on and/or turn-off of the instrument. The signaling means can either provide for selective automatic turn on and turn off of the drill, or to vary the speed of the drill. This totally eliminates the need for an electrical connection between the main supply unit and the remote control unit and again removes a potential safety hazard in the dentist's office and makes the equipment control more versatile and easier to adapt to various office conditions.

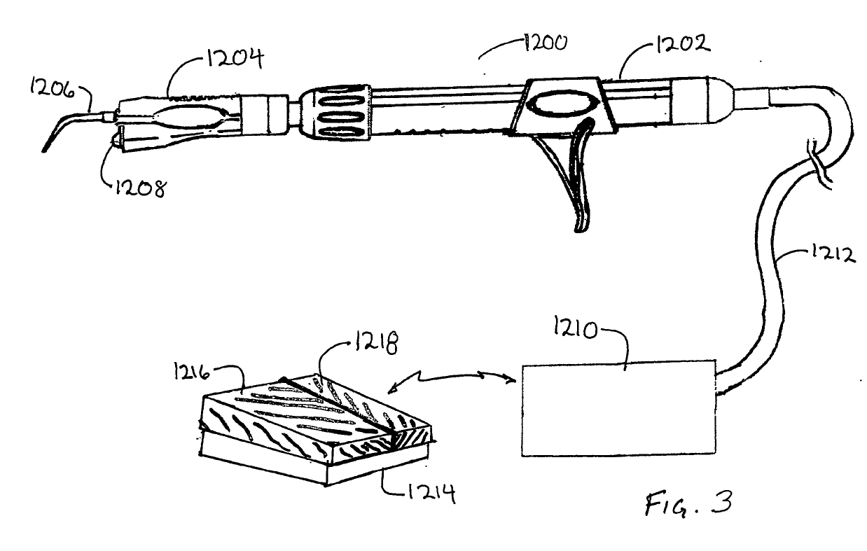

FIG. 3 shows a perspective view of a dental instrument 1200 according to one embodiment of the invention. According to the illustrated embodiment, the dental instrument 1200 includes a hand-piece 1202 and an insert 1204. The insert holds an ultrasonic scaler tip 1206 and includes a light source 1208 such as a light emitting diode. The handpiece 1202 is coupled to a supply apparatus 1210 with an umbilical cable 1212. In the illustrated case, the supply apparatus 1210 includes an ultrasonic power supply and a wireless receiver. Also shown is a foot-pedal device 1214. The foot-pedal device 1214 includes a first pedal portion 1216 adapted to control activation of the ultrasonic power supply within the supply apparatus 1210, and to thereby control activation of the ultrasonic scaler tip 1206. The foot-pedal device 1214 also includes a second pedal portion 1218 adapted to control a state of the light source 1208. According to various embodiments of the invention, applying pressure to the first foot-pedal portion 1216 allows simple on/off control of the ultrasonic tool 1206 or continuously varying control of the ultrasonic tool 1206. Also, according to various embodiments of the invention, applying pressure to the second foot-pedal portion 1218 allows simple on/off control of the light source 1208 or continuously varying control of the light source 1208.

Rotary dental instruments such as multi-use diamond dental burs; dental carbide burs; dental sintered diamond burs; dental diamond discs; dental laboratory tungsten carbide cutters; dental steel burs; and surgical drills are all contemplated in the present invention. These rotary dental inserts and other cutting tools for surgical placements of dental and orthopedic implants, developed to aid dental professionals in removing damaged portions of the tooth, including root canals, reconstructing and shaping the restored tooth or replacement tooth, including dental implants, all can be equipped with a wireless control.

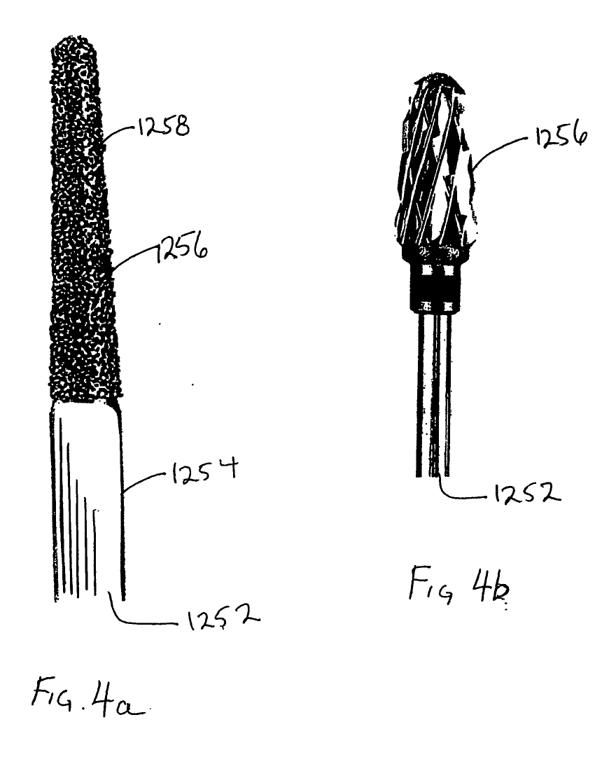

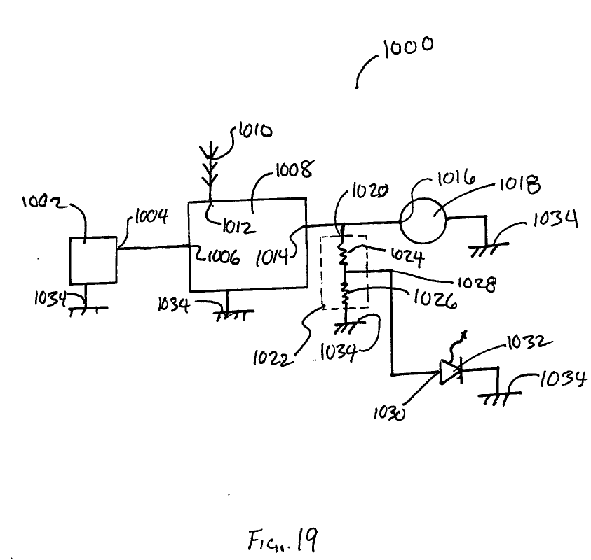

FIGS. 4a and 4b show exemplary rotary dental burs 1250. The FIG. 19a bur 1250 comprises a shank 1252 having a non-abrading shank portion 1254 adapted to be fitted into a dental handpiece (not shown), and an abrading working portion 1256 connecting to and extending outwardly from the non-abrading shank portion 1254. The abrading working portion 1256 comprises an abrading surface.

The shank 1252 can be made of any suitable metal, such as that used in the ultrasonic insert. The preferred materials are stainless steel and titanium alloys. These metals have good flexibility and resistance to torsional breakage.

The abrading surfaces can be formed in a number of different ways. One way of generating an abrading surface is by coating or embedding diamond particles or chips 1258 into the working surface of working portion 1256 of the substrate shank 1252. The abrading particles can in turn be coated with a coating such as a titanium nitride or a diamond-like carbon coating.

Another way of generating an abrading surface is by forming cutting surfaces or edges on the surface of the working portion 1256 of the shank 1252 as shown in FIG. 4b, connecting to and extending downwardly from the shank portion. The abrading portion can also comprise a coating, such as titanium nitride coating or diamond-like carbon coating.

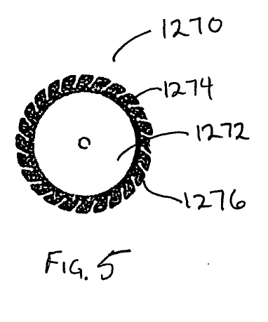

FIG. 5 shows an abrading tool for use in yet another embodiment of the invention. An abrading disc 1270 comprises a flexible substrate 1272 adapted for mounting onto a driver (not shown) and having diamond particles 1274 coated or embedded or having cutting edges 1276 formed thereon the surface of the substrate, the abrading surface can also be coated with a coating such as titanium nitride or flexible diamond-like coating that substantially covers the abrading surface during use. The disc can be attached to shank portion.

The flexible substrate 1272 can be made of metal or polymer. The surface of the substrate is coated or embedded with diamond particles 1274 having cutting edges formed thereon the surface of the substrate. The abrading surface can in turn be coated with a diamond-like carbon coating.

The materials suitable for use as a flexible substrate of the disc include those identified above as suitable also for the shanks of dental burs. One of skill in the art will appreciate that the desirable characteristics of substrate materials include good flexibility.

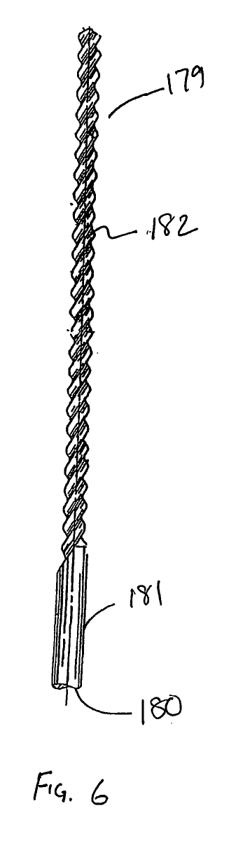

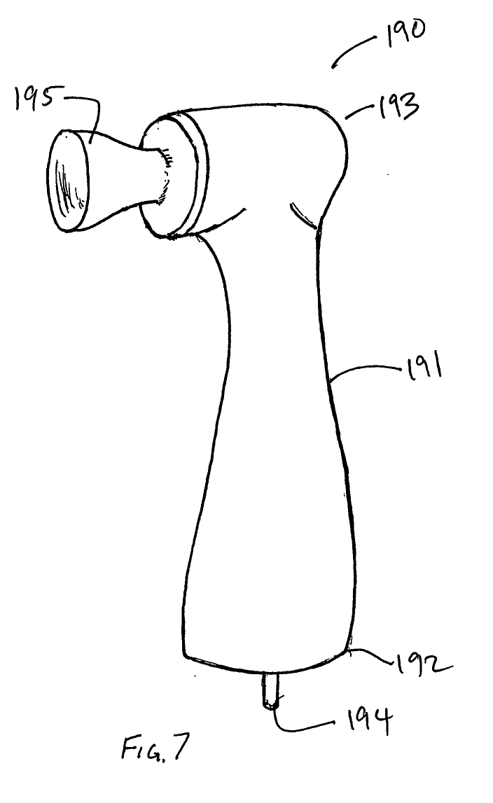

One of skill in the art will appreciate that a wide variety of other shapes and configurations of cutting tools may be employed in a dental tool having wireless remote control, such as the already mentioned dental drill, in the form of a drill bit insert (not shown) an endodontic file and reamer, as shown in FIG. 6 a prophy angle, as shown, for example, in FIG. 7, and such as those described in U.S. Pat. Nos. 4,097,995, 4,266,933, 4,854,870, 5,007,832, 5,028,233, 5,062,796, 5,156,547, 5,209,658, 5,328,369, 5,642,994, 5,667,383, 5,692,901, 5,697,773, 6,099,309 and 6,203,322, incorporated herein by reference.

In one preferred embodiment of the present invention, the above exemplary dental tools can also be fitted with at least one light source 101, as shown in FIG. 3 above. The light source can draw its power from the same or different power source that supplies the power for the operations of the tool, or the light source 1208 can draw its power from the already available ultrasonic vibrational energy already created by the ultrasonic vibrations.

The wireless control discussed above is also applicable here. As noted, the footswitch can be designed to indicate only on/off conditions where proportional control is not necessary, since some ultrasonic dental hygiene tools only need an on/off control. For such applications, the footswitch need only have two states, also to be described in more detail below.

As noted above, FIG. 6 shows a dental file adapted for use in a dental instrument according to the present invention. The dental file 179 includes a shaft 180 with a smooth portion 181 adapted to be collected to a rotary instrument and an abrasive portion 182 adapted to the shaping of tooth, bone, or other dental substrate. According to one preferred embodiment, the material of the dental file 179 is stainless steel. According to another preferred embodiment, the material of the dental file is an alloy of nickel and titanium. Further description of dental files suitable for employment within the invention is found in U.S. Pat. Nos. 5,527,205, 5,464,362, 5,941,760, 5,628,674, 5,655,950 and 5,762,541, incorporated herein by reference.

As also noted above, FIG. 7 shows a prophy angle attachment 190 according to one aspect of the invention. As illustrated, the prophy angle attachment includes a handle 191 with a proximal end 192 and a distal end 193. A mechanical coupling 194 at the distal end is adapted to receive mechanical power into the prophy angle. In the illustrated embodiment, a polishing cup 195 is coupled to a rotary mechanical output of the prophy angle at the distal end 193 thereof. As will be understood by one of skill of the art, wide variety of polishing and cutting tools may be employed in place of the polishing cup 195.

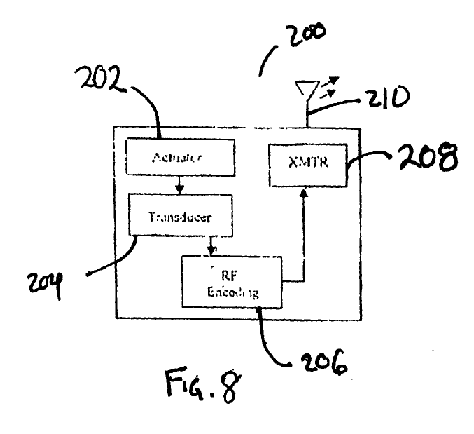

FIG. 8 shows, in block diagram form, a wireless transmitter 200 according to one aspect of the invention. The wireless transmitter includes an actuator 202, a transducer 204, a radio frequency modulator 206, a radio frequency transmitter 208, and an antenna 210. The actuator 202 is mechanically coupled to the transducer 204. The actuator 202 is adapted to receive a mechanical input, for example the pressure of a foot against a foot petal, and to provide a responsive mechanical output to the transducer 204. The transducer 204 receives the mechanical output of the actuator at a mechanical input of the transducer and produces a signal output, such as an electrical signal output at an output of the transducer. The signal output of the transducer 204 is received at an input of the radio frequency modulator 206. The radio frequency modulator 206 produces a radio frequency output that is received at an input of the radio frequency transmitter 208. The radio frequency transmitter 208 is electrically coupled to the antenna 210 and drives the antenna in accordance with the radio frequency signal that it receives from the radio frequency modulator 206.

According to one embodiment of invention, the actuator 202 is a foot pedal such as that identified with reference numeral 110 in FIG. 1. The transducer 204 senses a position and/or a motion of the foot pedal. According to one embodiment, the transducer 204 is an optical encoder device. Also according to one embodiment of invention, the actuator, transducer and RF encoding device produce a signal that is proportional to a mechanical signal applied to the actuator 202.

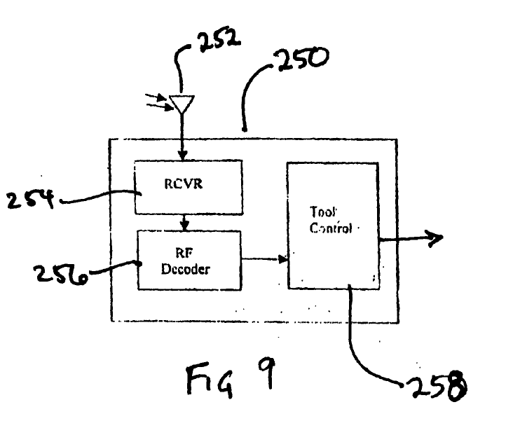

FIG. 9 shows, in block diagram form, a wireless receiver 250 for controlling a dental instrument. The wireless receiver includes an antenna 252, a receiver 254 and RF decoder 256, and a control device 258. The antenna 252 is coupled to the receiver 250 which is, in turn, coupled to the RF decoder 256. The RF decoder is coupled to the tool control 258. According to one embodiment of the invention, a signal received at the antenna 252 corresponds to a signal transmitted from the antenna 210 of transmitter 200 (as shown in FIG. 8). An output signal of the tool control 258 is thereby related to the mechanical signal applied to the actuator 202.

As shown in FIGS. 8 and 9, the actuating device connects to a transducer to convert the physical motion of the actuator into an electrical signal proportional to the motion of the actuator. The electrical signal representing the motion of the actuator is coded into a radio frequency signal that is transmitted by a low power RF transmitter through a small antenna 210. Alternatively, the actual position of the actuator can be converted to a digital signal, encoded into an RF signal, transmitted to the receiver 250, and decoded. It does not matter whether the signal carries position indicator or movement indicator signals. Either can be made to operate the dental tool when transmitted to a receiver 250.

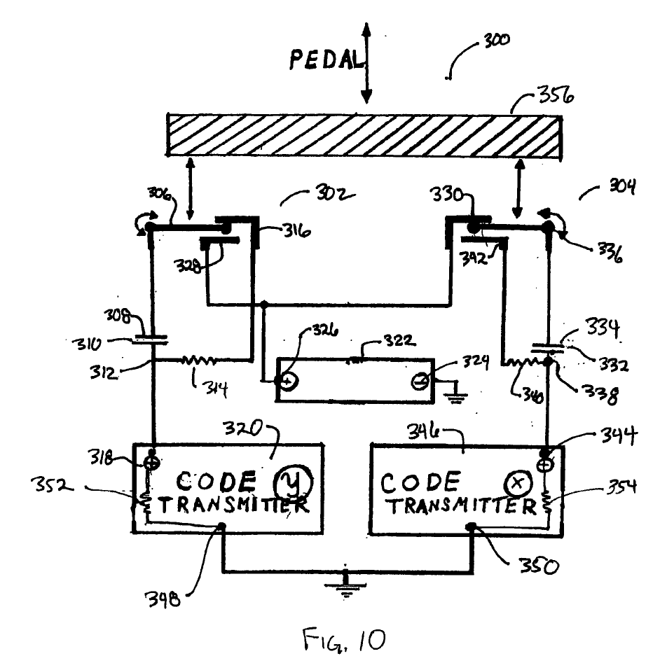

FIG. 10 shows, in block diagram form, a transmitter 300 for an energy-efficient wireless control system according to one embodiment of the invention. As will be understood by one of skill in the art, electrical batteries have a finite operational lifetime. Although some batteries are rechargeable, the time interval between charge cycles is nevertheless finite. To the extent that replacable or rechargeable batteries is required for a wireless transmitter according to the invention, the advantages of the invention are correspondingly limited. Therefore it is valuable to have a transmitter that conserves battery life. The transmitter 300 is adapted to transmit dental tool control signals without unduly taxing its battery.

Transmitter 300 includes a first single pole double throw (SPDT) switch 302 and a second SPDT switch 304. A common connection to 306 of switch 302 is coupled to a first capacitor terminal 308 of a capacitor 310. A second capacitor terminal 312 of capacitor 310 is coupled through a resistor 314 to a first output terminal 316 of switch 302. The output terminal 312 is also coupled to an input terminal 318 of a first code transmitter 320.

The footswitch sends a first signal when the actuator is pressed and a second signal when the actuator is released. The first signal, when received at the base unit, turns on the equipment. The reception of the second signal causes the equipment to turn off. In the footswitch, it is preferred that there is no electrical activity after the initial signal is sent so as to conserve energy in the battery that powers the device. The footswitch is preferably battery powered in most embodiments so that the cables presently needed for the footswitch operation can also be completely abandoned.

In this embodiment, powering only the signaling of an on and off signal allows the footswitch to operate for hundreds of activations before the battery must be replenished (if rechargeable) or replaced (if not).

One approach for such on/off control means is to provide an electrical circuit including switch means mounted within the remote control unit and coupled across a pair of conductive leads extending between the remote control unit and the supply source. The switch may be selectively turned on and off in order to respectively energize and deenergize the dental tool or instrument.

A battery 322 has a first battery terminal 324 coupled to ground and a second battery terminal 326 coupled to a second output terminal 328 of switch 302. Second battery terminal 326 is also coupled to a third output terminal 330 of switch 304. A second capacitor 332 includes a third capacitor terminal 334 coupled to a second common terminal 336 of switch 304. A fourth capacitor terminal 338 of capacitor 332 is coupled through a second resistor 340 to a fourth output terminal 342 of switch 304. The capacitor terminal 338 is also coupled to an input terminal 344 of a second code transmitter 346. The first and second code transmitters 320, 346 are mutually connected to ground at respective ground terminals 348, 350. Code transmitter 320 includes a first pulldown resistor 352 coupled between input terminal 318 and ground terminal 348. Code transmitter 346 includes a second pulldown transistor 354 coupled between input terminal 344 and ground terminal 350.

A pedal 356, or other actuator, is mechanically coupled to both switches 302 and 304. When the pedal 356 is depressed by a user, both switches 302 and 304 change their respective states substantially simultaneously.

In a preliminary state, prior to depression of the pedal capacitor 310 discharged and terminal 334 of capacitor 332 is charged to the voltage of battery 322 (e.g., 12 volts). Common terminal 306 is electrically connected to output terminal 316, and common terminal 336 is electrically connected to output terminal 330.

When the pedal is depressed, the states of the switches transition (state transition 1), so that common terminal 306 is electrically connected to output terminal 328 and common terminal 336 electrically connected to output terminal 342. In response to these electrical connections, terminal 308 of capacitor 310 rapidly charges to battery voltage and terminal 334 of capacitor 332 substantially discharges through resistor 340 and pulldown resistor 354 to ground potential. This discharging of terminal 334 occurs during a first transient time beginning immediately after state transition 1 and results in an electrical current that flows through resistors 340 and 354. A resulting first transient voltage appears that terminal 344. This first transient voltage is detected by internal circuitry of code transmitter 346, which responsively transmits a wireless signal indicating depression of the pedal.

It should be noted that the first transient time is of limited duration, as substantially determined by an RC time constant of capacitor 332 and resistors 340 and 354. Current flows from the battery 322 to terminal 308 of capacitor 310 during a similarly brief transient. Thereafter, no power is required from the battery until the next state transition, with the exception of power required to compensate for any leakage current of capacitor 310. Such leakage current will be substantially negligible.

When the pedal 356 is released, the states of the switches again transition (state transition 2). The terminal 334 of capacitor 332 is recharged by a transient current out of the battery 322. At the same time, terminal 308 of capacitor 310 discharges by way of switch terminals 306 and 316, resistor 314 and resistor 352 to ground. A consequent transient electrical current flows through resistors 349 and 352 that results in a transient voltage at terminal 318. This transient voltage is detected by internal circuitry of transmitter 320.

The transmitter 320 responsively transmits a wireless signal indicating release of the pedal. Again, power transmission from the battery 322 to capacitor 332 is limited by the brief duration of the second transient time interval.

The internal circuitry of transmitter 320 and 346 may be configured to transmit wireless signals of time and duration appropriate to the environment in which the wireless transmission system is to be employed. One of skill in the art will understand, however, that by limiting the duration of signal transmission, the power requirements of the transmitters 320, 346 may be correspondingly limited.

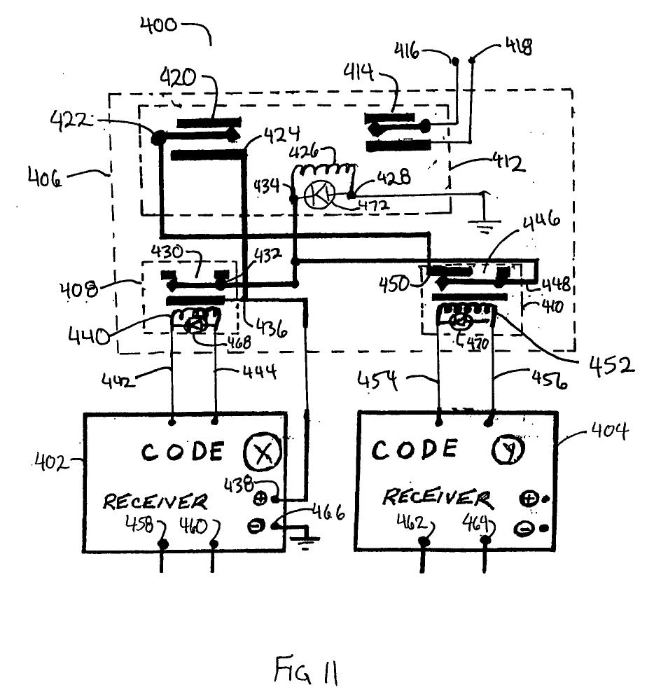

FIG. 11 shows a receiving circuit 400 of a wireless control system in block diagram form. In the illustrated embodiment, the receiving circuit 400 includes a first code receiver 402, a second code receiver 404 and a latch circuit 406. The latch circuit 406 includes a first single pole single throw electromechanical relay 408, a second single pole single throw electromechanical relay 410, and a double pole double throw electromechanical relay 412.

The double pole double throw electromechanical relay 412 includes a first switch 414. The first switch 414 has a first common terminal coupled to a second output terminal 416 of the latch circuit 406 and a third normally open terminal coupled to a fourth output terminal 418 of the latch circuit 406.

Relay 412 includes a second switch 420 with a fifth common terminal 422 and a sixth normally open terminal 424. Also included in relay 412 is an activation coil 426. The activation coil 426 is coupled at seventh output terminal 428 to a source of ground potential.

Relay 408 includes a third switch 430 with an eighth common terminal 432 coupled to a ninth input terminal 434 of activation coil 426. Relay 408 also includes a tenth normally open terminal 436 mutually coupled to input terminal 424 and to an eleventh output terminal 438 of first code receiver 402. Relay 408 also includes a second activation coil 440 with a pair of input terminals 442, 444 coupled to respective output terminals of the first code receiver 402.

Relay 410 includes a fourth switch 446 with a 12th common terminal 448 coupled to common terminal 432 of relay 408. Relay 410 also includes a 13th normally closed terminal 450 coupled to common terminal 422 of switch 420 (relay 412). Relay 410 also includes an activation coil 452 with a further pair of input terminals 454, 456 coupled to respective output terminals of the second code receiver 404.

First code receiver 402 is coupled to a power supply at power supply terminals 458, 460. Second code receiver 404 is coupled to a power supply at power supply terminals 462, 464. In addition, first code receiver 402 is coupled to a source of ground potential at a signal ground terminal 466. Flyback diodes 468, 470 and 472 are coupled across activation coils 440, 452 and 426 respectively.

In operation, code receiver 402 is adapted to receive a first signal from a corresponding first code transmitter, such as code transmitter 346 as shown in FIG. 10. Code receiver 404 is adapted to receive a second signal from a corresponding second code transmitter, such as code transmitter 420 as shown in FIG. 10. Responsive to the receipt of the first signal by code receiver and 402, latch circuit 406 is adapted to activate coil 426 and latch normally open switch 414 in a closed position, such that a substantially short circuit condition is provided between output terminals 416 and 418.

This substantially short-circuit condition may be used to control a dental instrument. For example, a power supply may be coupled in series with the switch 414 and the motor of an electric dental drill. Alternately, the power supplies may be coupled in series with the switch 414 and an ultrasonic power supply of an ultrasonic scaler instrument. In another example, a power supply may be coupled in series with an activation coil of a solenoid valve. The solenoid valve controls a flow of high-pressure air to a pneumatic dental instrument, such as a pneumatic dental drill.

The latch circuit 406 operates as follows. When code receiver 402 receives the first signal, it impresses an electrical voltage sufficient to activate coil 440 across terminals 442, 444. The resulting electromagnet of coil 440 closes switch 430 and produces a substantially short-circuit between terminals 432 and 436. Terminal 438 is thus switchingly coupled to terminal 434. The terminal 438 exhibits a voltage, taken with respect to ground terminal 466 (and thus with respect to terminal 428) that is sufficient to activate coil 426. The consequent electromagnet of coil 426 closes both switch 414 and switch 420.

As discussed above, the closure of switch 420 is adapted to activate a dental instrument. The closure of switch 420 provides a substantially short-circuit between terminals 422 and 424. This short-circuit, in series with normally closed switch 446 provides a current path that is electrically parallel to switch 430. The parallel current path couples output terminal 438 to input terminal 434 of coil 426. Consequently, coil 426 remains active after code receiver 402 stops providing the activation voltage across terminals 442 and 444, and after switch 430 responsively reopens.

Since the active state of coil 426 keeps both switch is 420 and 414 in their respective closed states, the dental instrument coupled to terminal 416 and 418 remains active. This active state persists until the circuit supplying coil 426 is broken by the activation of relay 410. The latch circuit 406 is said to be in a latched state.

When a second signal (such as that generated by code transmitter 320 of FIG. 10) is received by second code receiver 404, receiver 404 activates coil 452. Normally closed switch 446 is opened by active coil 452, and the electrical path supplying current to coil 426 is rendered discontinuous. As coil 426 is thus deactivated, switches 420 and 414 transition back to their open states, and the latch circuit 406 is said to be unlatched.

One of skill in the art will appreciate that the above described operation of receiving circuit 400 allows continuous operation of a dental tool, and subsequent termination of the tool's operation, to be effected with two signals, each signal being of a relatively brief duration. As described above, in relation to FIG. 10, it is beneficial to employ signals of brief duration in the context of a wireless dental instrument, since this allows conservation of battery life in, for example, a battery powered foot pedal transmitter.

As illustrated in FIGS. 10 and 11, the footswitch is designed to indicate only on/off conditions where proportional control is not necessary, as some dental hygiene tools, for example, an ultrasonic dental tool, only need an on/off control. For such applications, the footswitch need only have two states.

In FIG. 10, the footswitch is designed to send a first signal when the actuator is pressed and a second signal when the actuator is released. The first signal, when received at the receiver 400, turns on the equipment. The reception of the second signal causes the equipment to turn off. In the footswitch, it is preferred that there is no electrical activity after the initial signal is sent so as to conserve the power in the battery that powers the device. The footswitch is preferably battery powered in most embodiments so that the cables presently needed for the footswitch operation can also be completely abandoned.

In this embodiment, powering only the signaling of an on and off signal allows the footswitch to operate for hundreds of activations before the battery must be replenished (if rechargeable) or replaced (if not).

It should be noted that the embodiments described above in relation to FIGS. 10 and 11 are merely exemplary. For example the latch circuit 406 of FIG. 11 could really be implemented with, for example, transistor gates rather than electromechanical relays. Moreover, the plural code transmitters of FIG. 10 and code receivers of FIG. 11 could readily be implemented as a single transmitter and a single receiver respectively. In addition, in light of the foregoing disclosure, one of skill in the art would understand that there are other means of producing a signal of limited duration, such as by digital timer or by analog delay line.

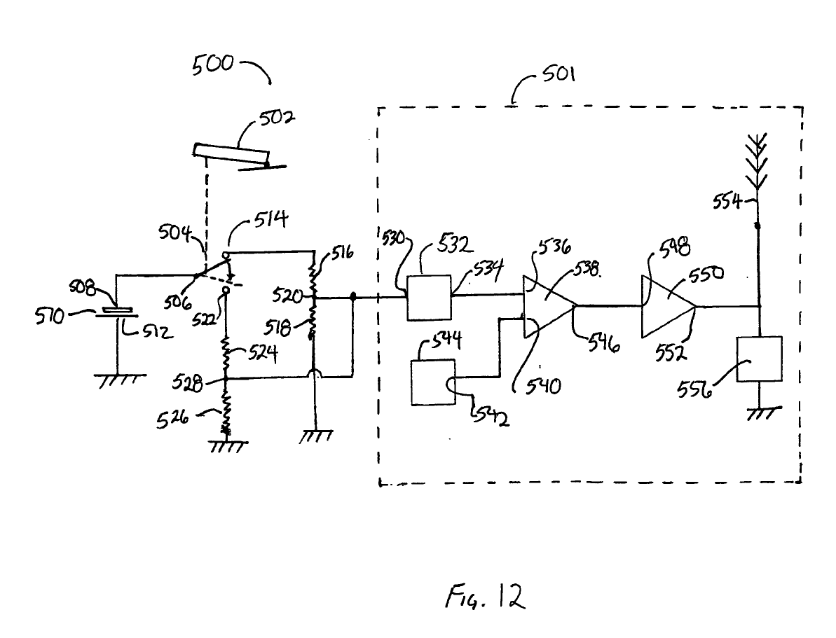

FIG. 12 shows, in block diagram form, a wireless transmitter 500 according to one embodiment of the invention. In the illustrated embodiment, a single radio transmitter circuit 501 is employed to send more than one signal. The wireless transmitter includes a foot pedal 502 operatively coupled to a mechanical input of a single pole double throw switch 504. The switch 504 has a first common input terminal 506 coupled to a second terminal 508 of a power source such as, for example, an electrochemical battery. A third terminal 512 of the power source is coupled to a common node or source of ground potential.

A fourth terminal 514 of switch 504 is coupled through a first voltage divider to the source of ground potential. The first voltage divider includes first 516 and second 518 resistors mutually coupled in series at common fifth terminal 520.

A sixth terminal 522 of switch 504 is coupled through a second voltage divider to the source of ground potential. The second voltage divider includes third 524 and fourth 526 resistors mutually coupled in series at a common seventh terminal 528.

Terminals 520 and 528 are mutually coupled to an input terminal 530 of a voltage controlled oscillator 532. As is understood by those of ordinary skill of the art, a voltage controlled oscillator produces an output signal having a frequency related to a voltage applied at an input of the oscillator 532.

The ratio of resistances, of resistors 516 and 518, of the first voltage divider are selected to be different from the ratio of resistances, of resistors 524 and 526, of the second voltage divider. Consequently, the electrical potential of input terminal 530 depends on a state of the switch 504. Because the output frequency of the oscillator 532 depends on the potential of input terminal 530, changing the state of switch 504 changes a frequency of a signal output at output terminal 534.

The output terminal 534 is coupled to an input terminal 536 of a modulator 538. A further input terminal 540 of modulator 538 receives a radio frequency signal from an output 542 of a radio frequency oscillator 544. The modulator 538 produces a modulated signal at an output 546.

The modulated signal is received at an input 548 of a radio frequency amplifier 550 which produces an amplified radio frequency signal at its output 552. The output 552 of the radio frequency amplifier 550 is mutually coupled to an antenna 554 and, through a ballast or load 556, to a source of ground potential.

In operation, the wireless transmitter 500 is placed on the floor of examining room at a location convenient to the foot of the dentist. When the dentist wishes the dental tool to operate, he or she depresses the foot pedal 502. This causes switch terminal 506 to be electrically connected to terminal 522. Accordingly, the voltage of battery 510 is applied across resistors 524 and 526.

As is understood by one of skill of the art, a resulting first signal voltage is impressed at node 528 that is different from the voltage of battery 510, and depends upon the voltage of battery 510 and upon the resistance values of resistors 524 and 526. This first signal voltage is received at input 530 of voltage controlled oscillator 532. It is characteristic of a voltage controlled oscillator that an output frequency at output 534 corresponds to the voltage input at terminal 530. Thus a first output frequency is received at modulator 538. The modulator 538 mixes this first output frequency with a radio frequency carrier signal received from RF oscillator 544. The resulting mixed (or RF modulated) signal it amplified with RF amplifier 550 and the resulting amplified signal is used to drive antenna 554. This results in the broadcasting of a first modulated RF signal over an area determined principally by the signal power available from the RF amplifier 550 and the configuration of the antenna 554.

When the foot pedal 502 is released, the connection between terminals 506 and 522 is broken. Immediately thereafter, a new connection is formed between terminal 506 and terminal 514. This acts to couple resistors 516 and 518 in series with battery 510. The voltage of battery 510 is dropped across the series combination of resistors 516 and 518, producing a second signal voltage at node 520. This second signal voltage produces a second frequency at the output 534 of the voltage controlled oscillator 532. As with the first signal frequency, this second signal frequency is RF and modulated in the modulator 538, amplified in the RF amplifier 550, and broadcast as a second RF signal from the antenna 554.

The first and second RF signals are received at a receiving apparatus that includes a control system adapted to, for example, turn on a dental instrument in response to receiving the first RF signal and turn off the dental instrument in response to receiving the second RF signal.

It will be understood by one of skill in the art that, in a further embodiment, the switch 504 may be replaced with a pulse generator circuit adapted to respond to an input from foot pedal 502 by connecting terminal 506 and 514 for a particular time interval. The pulse generator circuit may be configured to connect terminal 506 to terminal 522 for a second particular time interval upon release of the foot pedal 502. In this way, savings in battery lifetime, along the lines of those described above in relation to FIGS. 10 and 11, may be achieved.

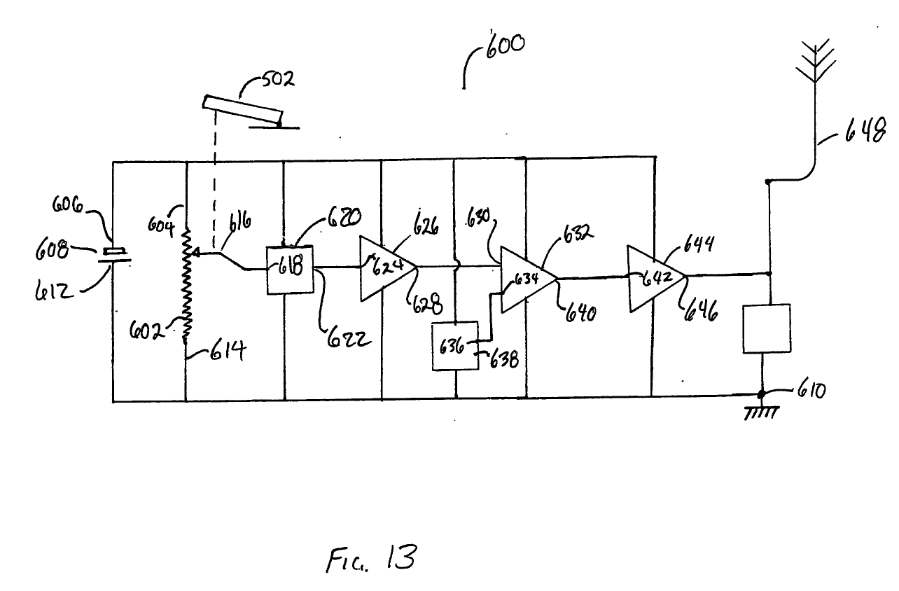

FIG. 13 shows a wireless transmitter 600 according to another embodiment of the invention, in block diagram form. As shown in FIG. 13, a foot pedal 502 is mechanically coupled to a mechanical input of a variable resistor 602. The variable resistor 602 has a first terminal 604 coupled to a second terminal 606 of an electrical battery 608. A third terminal 612 of the electrical battery 608 is coupled to a common node 610, which is, in one embodiment, at ground potential. A fourth terminal 614 of the variable resistor 602 is also coupled to the common node 610.

The mechanical input of resistor 602 is adapted to vary respective resistances between output terminal 616, and terminals 604 and 614. Consequently, the voltage divider arrangement shown produces a voltage at terminal 616 that varies in relation to the degree to which foot pedal 502 is depressed.

The variable voltage at terminal 616 is received at an input 618 of a voltage controlled oscillator 620. The voltage controlled oscillator also has a first power supply terminal coupled to battery terminal 606 and second power supply terminal coupled to common node 610. An output 622 of the voltage controlled oscillator is coupled to an input 624 of a buffer amplifier 626.

An output 628 of the buffer amplifier 626 is coupled to a first input 630 of a modulator circuit 632. A second input 634 of the modulator circuit is connected to an output 636 of a radio frequency oscillator 638. The modulator circuit 632 has an output 640 coupled to an input 642 of a radio frequency (RF) amplifier 644. An output 646 of the RF amplifier is mutually coupled to an antenna 648 and, through a ballast, to a source of ground potential.

Like the voltage controlled oscillator 618, the buffer amplifier 626, the modulator circuit 632 and the RF amplifier each has a power terminal coupled to battery terminal 606 and a power terminal coupled to common node 610.

In operation the foot pedal 502 is placed at a convenient location for access by the dental professional. When the dental professional wishes to activate a dental tool controlled by the foot pedal, he or she presses on the foot pedal 502. As will be understood by one of skill in the art, the foot pedal is mechanically coupled to a wiper of the variable resistor 602. Moving the wiper over the internal resistance element of the variable resistor forms a continuously varying voltage divider. The voltage output at terminal 616 depends on the voltage of battery 608 and the relative resistances of the portions of resistor 602 above and below the wiper.

The result, at terminal 616, is a continuously varying voltage, having a value at any particular moment that is related to the activation of the foot pedal at that particular moment. This voltage at terminal 616 is applied to the input 618 of voltage controlled oscillator 620. In response to the voltage at terminal 616 at a particular moment, the voltage controlled oscillator produces a corresponding output signal at output 622. The output signal has a frequency with an instantaneous value corresponding to the voltage at terminal 616, which is related to the degree to which pedal 502 is depressed. This output signal is amplified in amplifier 626, RF modulated in modulator 634, RF amplified in amplifier 644 and broadcast via antenna 648. Because the RF modulated signal broadcast by antenna 648 contains a continuously varying signal that may be extracted by receiver, a dental instrument coupled to receiver may be controlled in continuous fashion. For example, a rotary drill may be controlled from a stopped state continuously to a state of maximum rotation. In another example, and ultrasonic scaler may be controlled from a stopped continuously to a state of maximum vibration in amplitude and/or frequency.

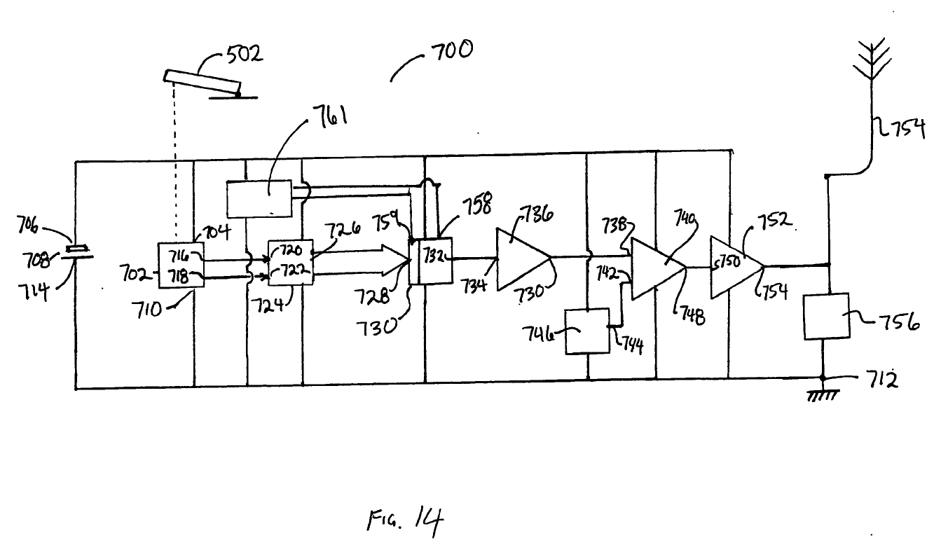

FIG. 14 shows a transmitter circuit 700, according to a further embodiment of the invention, in block diagram form. In the embodiment of FIG. 14, a foot pedal 502 is operatively coupled to a mechanical input of a digital encoder device 702. The digital encoder 702 includes a first power terminal 704 coupled, for example, to a first battery terminal 706 of an electrochemical battery 708 and a second power terminal 710 coupled to a common node (such as a grounded node) 712.

The battery 708 includes a second battery terminal 714 coupled to the common node 712. In the illustrated embodiment, the digital encoder produces a pulse train signal at a first output port 716 and a second sense signal at a second output port 718. The first 716 and second 718 output ports are coupled to respective third 720 and fourth 722 input ports of a digital up/down counter 724. A fifth parallel output port 726 of the digital up/down counter 724 is adapted to output a digital count value in parallel format.

The parallel output port 726 is coupled to a parallel input port 728 of a modem circuit 730. The modem circuit 730 includes a parallel to digital shift register adapted to convert a parallel count value received from the digital up/down counter 724 into a serial bit-stream. In addition, in various embodiments the modem circuit 730 includes additional devices adapted to insert control bits such as stop and start bits into a serial bit stream output from a serial output port 732 of the modem circuit 730.

The modem circuit 730 also includes first 758 and second 759 clock inputs. Clock inputs 758 and 759 are signalingly coupled to respective clock outputs of a clock and control circuit 761. Clock signals received from the clock and control circuit 761 control the latching of parallel data at input port 728 and the subsequent serial output of that data at output port 732.

In the illustrated embodiment, the serial output port 732 is coupled to an input port 734 of a signal amplifier 736. An output 738 of the signal amplifier 736 is coupled to a low-frequency input 738. A high frequency input 742 of the modulator circuit 740 is coupled to an output 744 of an RF oscillator 746.

A modulated signal output 748 of the modulator circuit 740 is coupled to an input 750 of an RF amplifier 752. An output 754 of amplifier 752 is coupled to an antenna 754 and, through a ballast circuit 756, to common node 712 and thus to ground.

Power is supplied to the digital encoder 702, the digital up/down counter 726, the modem circuit 730, the signal amplifier 736, the modulation circuit 740, the RF oscillator 746, and the RF amplifier 752 by way of respective power terminals, each coupled to battery terminal 706, and ground terminals, each mutually coupled to the common node 712 (and thus to battery terminal 714).

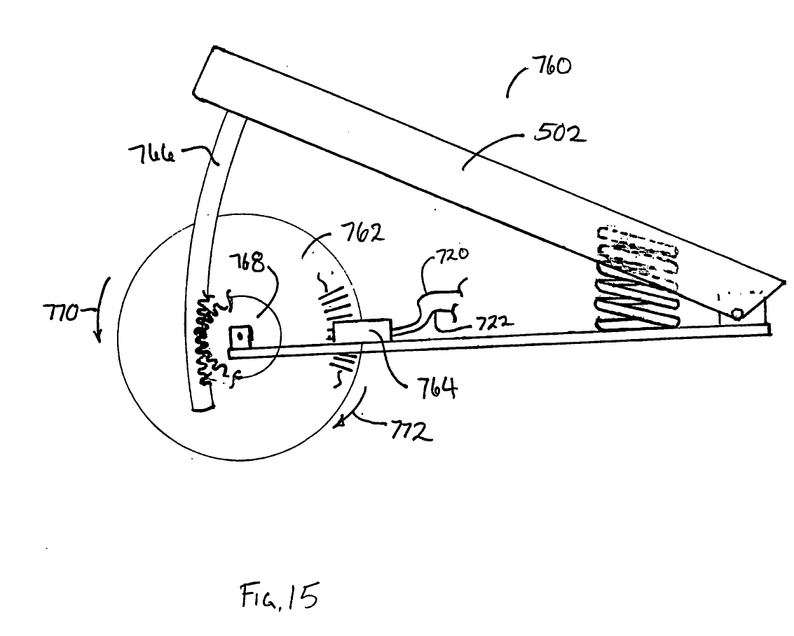

FIG. 15 shows an exemplary foot pedal device 760 such as would be employed in various embodiments of the invention. The foot pedal device 760 includes a foot pedal 502, a rotary encoder disk 762, an integrated sensor module 764 with a pulse train output 720 and a sense output 722. As is known in the art, the integrated sensor module may include, for example, an optical source and an optical detector, along with a Schmidt trigger and amplification circuitry. In other embodiment, the integrated sensor module may include a magnetic sensor such as a Hall effect sensor. The pedal device 760 also includes a rack 766 and pinon 768 mechanism adapted to rotate the rotary encoder disk 762 in a first direction 770 as the foot pedal 502 is progressively depressed, and in a second direction 772 as the foot pedal 502 is progressively released.

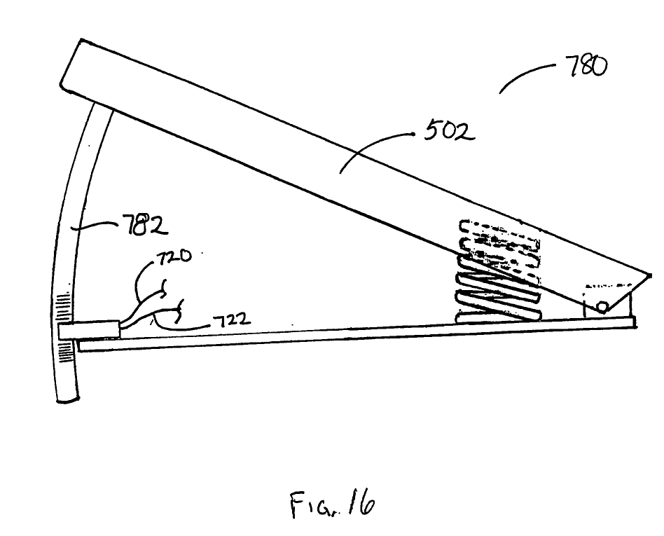

FIG. 16 shows a further exemplary foot pedal device 780. Like foot pedal device 760, foot battle device 780 includes a foot pedal 502, an integrated sensor module 764 with a pulse train output 720 and a sense output 722. Unlike foot pedal device 760, foot pedal device 780 includes a linear encoder grating 782 instead of a rotary encoder disk.

One of skill in the art will appreciate that the foregoing disclosure teaches a variety of alternative embodiments including such alternative position and motion transducers as, for example, rotary resolver devices, linear resolver devices, ultrasonic position measuring devices and linear Hall effect magnetic position measuring devices, among others.

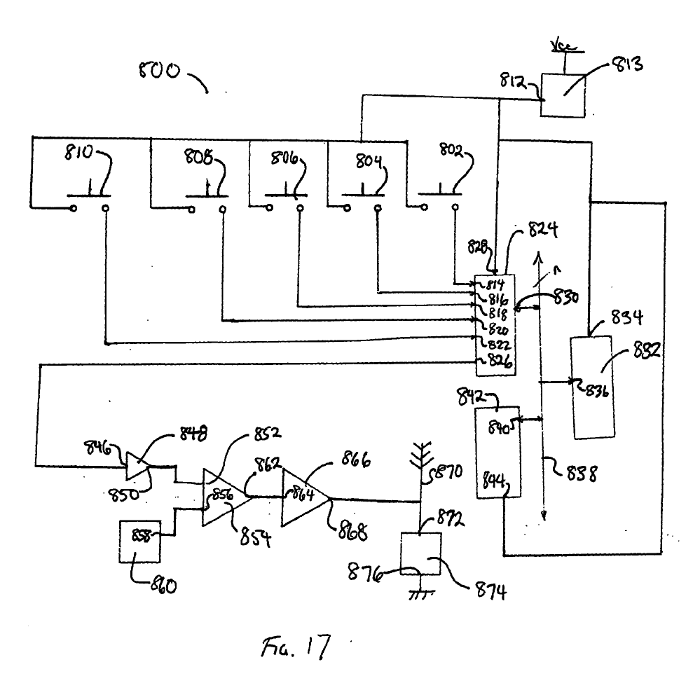

FIG. 17 shows a signal transmitter 800, including a microprocessor, according to another further embodiment of the invention. As illustrated, signal transmitter 800 includes a plurality of pushbutton switches. These pushbutton switches may be mechanically coupled to a corresponding plurality output switches, or to a combination of foot and hand switches, according to various exemplary embodiments of the invention. The pushbuttons include a first pushbutton 802, a second pushbutton 804, a third pushbutton 806, a fourth pushbutton 808, and a fifth pushbutton 810.

Pushbutton 802 is adapted to increase the speed, power, or other operating parameter of a dental tool with which the signal transmitter 800 communicates. Pushbutton 804 is adapted to reduce the speed, power, or other operating parameter of the dental tool. Pushbutton 806 is adapted to immediately reduce to zero the power, or other operating parameter of the dental tool. Pushbutton 808 is adapted to turn on a light, water jet, air jet, or other ancillary feature of the dental tool and pushbutton 810 is adapted to turn off the light, water jet, air jet, or other and slurry feature of the dental tool.

Each pushbutton 802, 804, 806, 808, 810 includes a first terminal mutually coupled to an output node 812 of a power control device 813. A second terminal of each pushbutton is coupled to a respective input terminal 814, 816, 818, 820, 822 of an I/O port device 824. The I/O port device 824 also includes an output terminal 826, a power supply terminal 828 and a port 830 (typically a parallel port) for receiving and sending data and control signals.

The signal transmitter 800 also includes a microprocessor 832 with a power supply terminal 834 and a port 836 (typically a parallel port) for receiving and sending data and control signals.

A data and control bus 838 is mutually coupled between data and control port 830 and data and control port 836. In addition, data and control bus 838 is coupled to a data and control port 840 of a memory device such a read-only memory device 842. In the illustrated embodiment, the memory device also includes a power supply terminal 844. The power supply terminal 844 is mutually coupled with a power supply terminal 834 of the microprocessor 832, with the power supply terminal 828 of the I/O port 824, and with the output node 812 of the power control device 813.

In the illustrated embodiment, output terminal 826 of I/O port device 824 is coupled to an input 846 of a buffer amplifier 848. An output 850 of buffer amplifier 848 is coupled to a first input 852 of a modulation circuit 854. A second input 856 of modulation circuit 854 is coupled to a output 858 of an RF oscillator 860. The modulation circuit 854 includes an output 862 coupled to an input 864 of an RF amplifier 866. The RF amplifier 866 has an output 868 coupled to an antenna 870. The output 868 of the RF amplifier 866 is also coupled to an input 872 of an antenna ballast 874. According to one embodiment of the invention, the antenna ballast 874 also includes a terminal 876 coupled to a source of ground potential.

When foot pedal 502 (as seen for example, in FIG. 15) is depressed, it causes a digital pulse train to be sent from the optical encoder 762 (as seen in FIG. 14) to the up/down counter 724. With further reference FIG. 14, the pulses of this digital pulse train are counted by the counter, which increments were decrements a count value that it maintains internally. On a periodic basis, as determined by the clock/controller 761 this count is converted from parallel to serial form by the multiplexer 730. The resulting serial digital signal is used by modulator 740 to RF modulate an RF carrier signal produced by RF oscillator 746. The resulting RF modulated signal is amplified by amplifier 752 and broadcast via antenna 754.

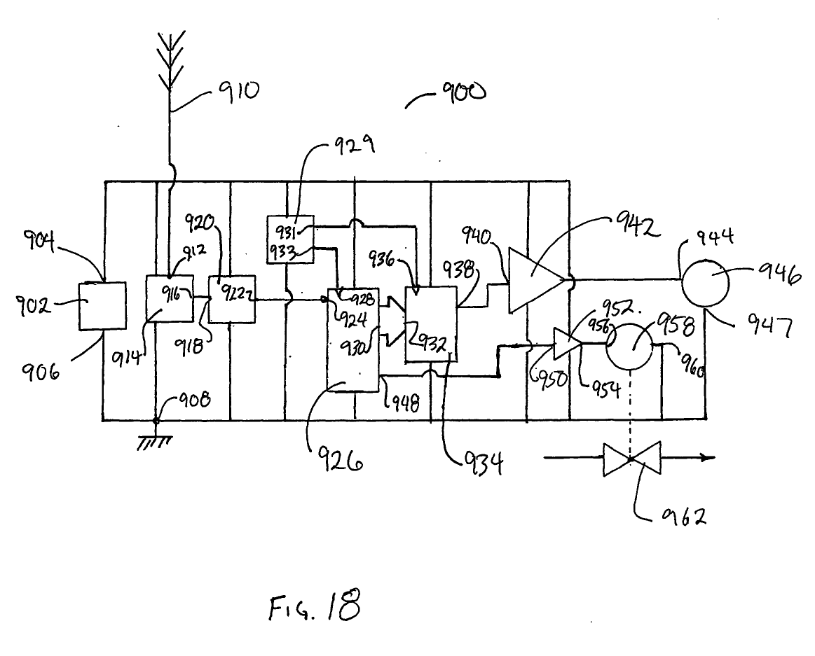

FIG. 18 shows a wireless receiver 900, in block diagram form, according to one embodiment of the invention. As illustrated, the wireless receiver 900 includes a power supply 902. The power supply 902 includes a first power terminal 904 and a second power terminal 906. The second power terminal 906 is coupled to a common node 908. According to one embodiment of the invention, the second common node 908 is coupled to a source of ground potential.

An antenna 910 is coupled to a first input 912 of a preamplifier circuit 914. The preamplifier circuit 914 includes an output 916 coupled to an input 918 of a demodulator circuit 920. According to one aspect of the invention, the demodulator circuit 920 includes an RF oscillator and is adapted to extract a modulation signal from and amplified RF signal received from the antenna 910 by way of the preamplifier circuit 914.

An output 922 of the demodulator circuit 920 is coupled to a serial input 924 of a demultiplexer circuit 926. In addition, in a typical embodiment the demultiplexer circuit 926 includes a serial input parallel output shift register along with control circuitry adapted to detect and interpret ancillary bits such as start and stop bits. The demultiplexer circuit 926 also includes a clock input 928 and a parallel digital output 930.

The parallel digital output 930 of the demultiplexer circuit 926 is coupled to a parallel digital input 932 of a digital to analog converter 934. The digital to analog converter 934 includes a clock input 936 and an analog output 938.

A clock and control device 929 includes a first clock output 931 coupled to clock input 928 and a second clock output 933 coupled to clock input 936.

The analog output 938 is coupled to an input 940 of a power control circuit 942. According to one embodiment of the invention, the power control circuit is a linear power amplifier, or a switched power amplifier adapted to control the drill motor of a rotary electric dental tool. According to another embodiment of the invention, the power control circuit is coupled to an ultrasonic power supply, including an ultrasonic oscillator and power amplifier. The ultrasonic power supply is adapted to control an ultrasonic dental tool. According to a further embodiment, an output of the power control circuit 942 is coupled to an input 944 of a dental tool 946 such as an electric rotary dental drill. According to one embodiment of the invention, the electric rotary dental drill also includes a further terminal 947 coupled to the common node 908.

In a further aspect, according to one embodiment, the invention includes a further digital output 948 of the demultiplexer circuit 926. The further digital output 948 is coupled to an input 950 of a buffer amplifier 952. The buffer amplifier 952 has an output 954 coupled to a first terminal 956 of a solenoid valve activation coil 958. A second terminal 960 of the solenoid valve activation coil 958 is coupled to common node 908. The solenoid valve activation coil 958 is magnetically coupled to a valve 962, such as a water control valve or air control valve.

In a further aspect of the invention, power terminal 904 of power supply 902 is coupled to respective power input of the preamplifier 914, the demodulator 920, the clock and control device 929, the demultiplexer 926, the digital to analog converter 934, the power control circuit 942 and the buffer amplifier 952. In like fashion, respective brown terminals of the preamplifier 914, the demodulator 920, the clock and control device 929, the demultiplexer 926, the digital to analog converter 934, the power control circuit 942 and the buffer amplifier 952 are coupled to common node 908.

FIG. 19 shows a wireless receiver 1000 according to another embodiment of the invention. The wireless receiver 1000 of FIG. 19 is adapted to control both a mechanical tool portion of a dental instrument and a light source associated with the dental instrument. Accordingly, the wireless receiver 1000 includes a power supply 1002 with a power output 1004. The power output 1004 is coupled to a power input 1006 of a wireless receiving device 1008. An antenna 1010 is coupled to an antenna input 1012 of the receiving device 1008. A power output 1014 of the receiving device 1008 is coupled to a power input 1016 of a motor 1018, such as a rotational motor or a vibratory motor, of the dental tool. The power output 1014 of the receiving device 1008 is also coupled to an input 1020 of a voltage modifying device 1022.

In the illustrated embodiment, the voltage modifying device 1022 is a voltage divider including a first resistor 1024 and a second resistor 1026. An output of the voltage modifying device 1022 includes a node 1028 between the two resistors 1024 and 1026. Node 1028 is electrically coupled to an input 1030 of a light source 1032, such as a light emitting diode, or an array of light emitting diodes. The light emitting diode 1032, the motor 1018, the voltage modifying circuit 1022, the wireless receiving device 1008, and the power supply 1002 all include a mutual connection to a common node 1034. According to one embodiment of the invention, the common node 1034 is maintained at ground potential.

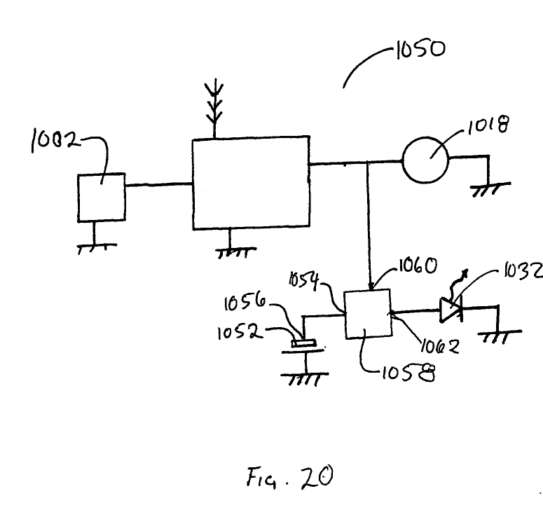

It should be noted that the wireless receiver 1000 is best adapted to be used with a dental instrument where simple on-off control of the motor 1018 is required. Under such circumstances, the electrical potential maintained at the output 1014 of the wireless receiving device 1008 may be either zero Volts, or a substantially constant non-zero voltage. Under such circumstances, the illumination produced by the light source 1032 also will be substantially constant. Alternately, where stepped or continuously varying control of the motor 1018 is desired, it is appropriate to provide a separate controlled power source for the light source 1032. FIG. 20 shows one exemplary embodiment of such an arrangement.

FIG. 20 illustrates a wireless control circuit receiver 1050 according to still another embodiment of the invention. Like wireless receiver 1000, wireless receiver 1050 includes a power supply 1002 a motor 1018 and a light source 1032.

Unlike wireless receiver 1000, however, wireless receiver 1050 includes a separate controlled power supply for the light source. In the illustrated embodiment, this power supply is an electrochemical battery 1052. A first terminal of the electrochemical battery is connected to a common or ground node. A second terminal 1056 of the battery 1052 is coupled to an input 1054 of a control device 1058.

According to one embodiment of the invention, the control device 1058 includes a switching transistor. According to another embodiment of the invention, the control device 1058 includes an electromechanical relay. The control device 1058 includes a control input 1060 adapted to receive an electrical signal. In response to the electrical signal received at control input 1060, an output terminal 1062 is electrically connected to or disconnected from input terminal 1054. Output terminal 1052 is coupled to an input of a light source, such as the illustrated light emitting diode 1032. Consequently, whether the light emitting diode 1032 is illuminated or dark depends on a state of the signal received at control input 1060. Furthermore, because the light emitting diode 1032 has at its power source battery 1052, the illumination provided by the diode 1032 remains substantially invariant as the power supplied to the motor 1018 is varied.

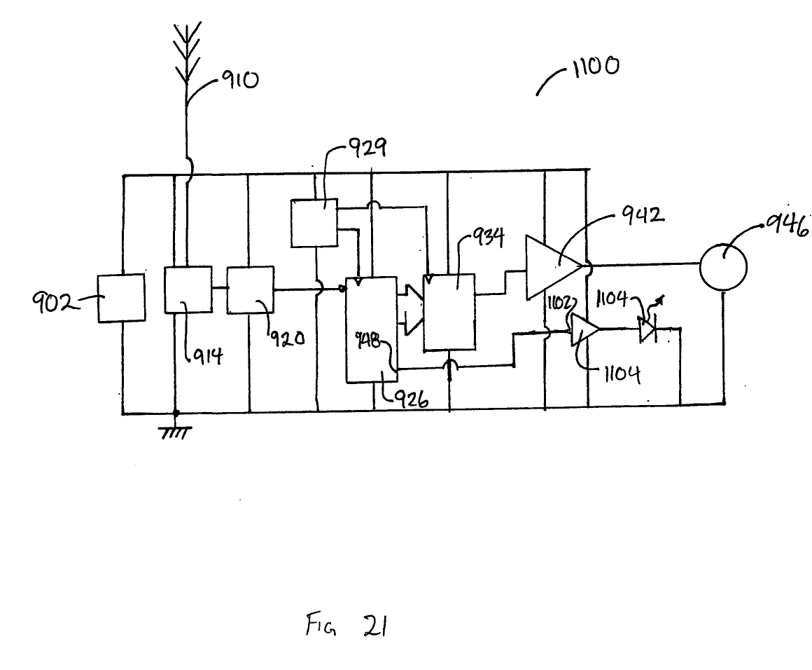

FIG. 21 shows, in block diagram form, still another example of a wireless receiver 1100 for control of a dental instrument according to the invention. In wireless receiver 1100, a configuration similar to that of wireless receiver 900 (as shown in FIG. 18) is used to control both a mechanical transducer and a light source.

Like wireless receiver 900, wireless receiver 1100 includes a power supply 902, an antenna 910, a preamplifier circuit 914, a demodulator circuit 920, a demultiplexer circuit 926, a clock and control device 929, a digital to analog converter 934, a power control circuit 942 and a dental tool 946 such as an electric rotary dental drill or an ultrasonic vibrational dental scaler.

As illustrated, the multiplexer circuit 926 includes a digital output 948. The digital output 948 is coupled to an input 1102 of a driver or device 1104. The driver or device is electrically coupled to the power supply 902, from which it receives electrical power, and includes an output coupled to a light source such as a light emitting diode 1104.

The wireless receiver 1100 is adapted to receive a radiofrequency signal and, based on the information content of that radiofrequency signal, control a level of electrical power delivered by drive circuit 942 to the dental tool 946 and also control an on or off state of light source 1104.

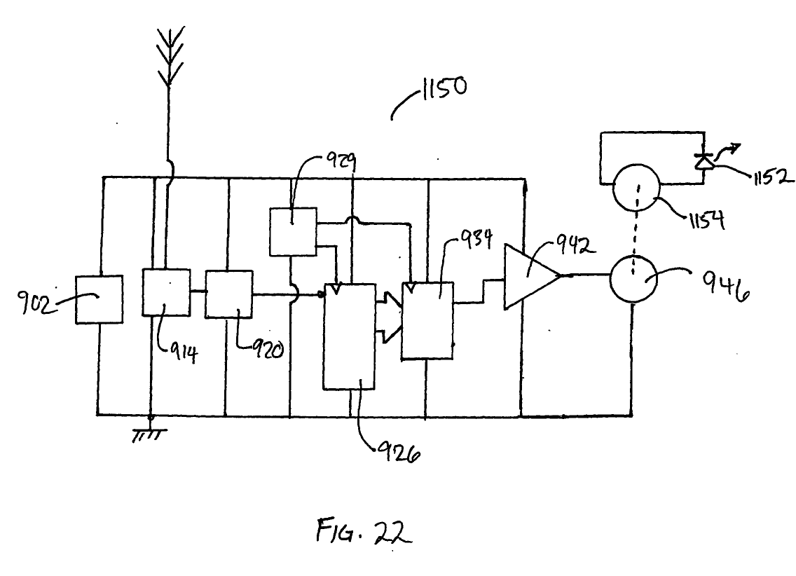

Wireless receiver 1150, as shown in FIG. 22, is also similar in some aspects to wireless receiver 900. Like wireless receiver 900, wireless receiver 1100 includes a power supply 902, an antenna 910, a preamplifier circuit 914, a demodulator circuit 920, a demultiplexer circuit 926, a clock and control device 929, a digital to analog converter 934, a power control circuit 942 and a dental tool 946 such as an electric rotary dental drill or an ultrasonic vibrational dental scaler. In wireless receiver 1150, however, no separate digital signal is provided for control of the light source. Instead, a light source 1152 is electrically coupled to an electric generator 1154. The electric generator 1154 is, in turn, mechanically coupled to an electromechanical transducer of the dental tool 946.

For example, the electric generator 1154 may include a piezoelectric generator mechanically coupled to a piezoelectric transducer of the dental tool 946 and adapted to receive mechanical power therefrom. In this way, a portion of the electrical energy transmitted from the power control circuit to the dental tool 946 is converted by the dental tool 946 into mechanical energy, and then converted back into electrical energy for the purpose of powering the light source 1152.

FIGS. 20 and 22 show the light source having a separate power supply.

A wireless control means for the selective energizing of the light supply source can be separate or the same as the wireless means that controls the on and off state of the mechanical transducer of the dental tool. If a separate control is used, it can also be located within easy reach of the operator to permit turn-on and/or turn-off of the light supply source through simple foot pedal control provided within a remote control unit.

In particular, FIG. 22 shows the light source drawing its power from the ultrasonic vibrations of the ultrasonic transducer, as described in patent application Ser. No. 10/879,554 entitled “Ultrasonic dental tool having a light source”, incorporated herein by reference. By way of example, a transducer such as and/or including an illumination energy coil is provided and attached to the light source such that the light source is energized using vibrational energy converted by the transducer.

According to one embodiment of the invention, the activation of the ultrasonic insert is controlled by the wireless foot control (110 as shown e.g., in FIG. 1 above). Depressing the foot control will result in activation of the ultrasonic handpiece, the light source and also delivery of cooling water to the insert tip. When the foot is removed from the foot control, the ultrasonic handpiece as well as the light source and water are shut off.

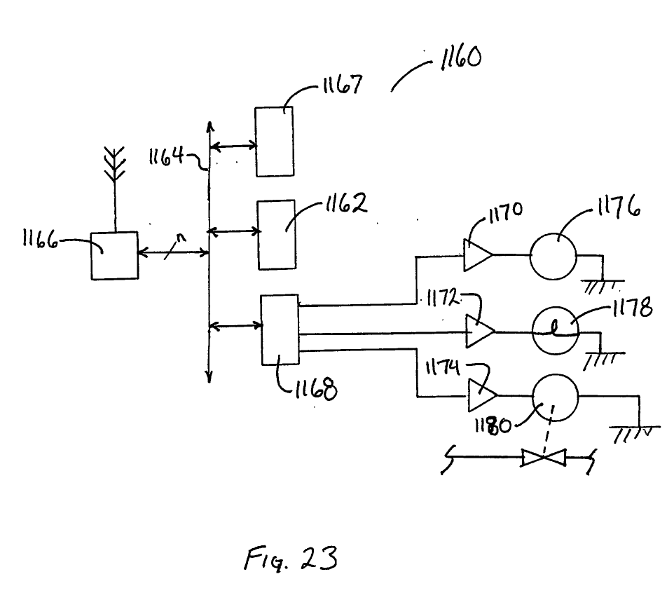

FIG. 23 shows a further embodiment of a wireless receiver 1160 according to the invention. In this embodiment the receiver 1160 includes a microprocessor 1162. The microprocessor is coupled to a data and control bus 1164. The data and control bus is, in turn to coupled to receive circuit 1166 and, for example, a read only memory 1168. The data and control bus is also coupled to an I/O port device 1168. The I/O port device 1168, is, in turn, coupled to first 1170, second 1172, and third 1174 driver circuits.

The first driver circuit 1170 is coupled to an electromechanical transducer 1176, such as a motor, or piezoelectric oscillator, as would be founded a dental instrument. The second driver circuit 1172 is coupled to a light source 1178, such as an incandescent light, a fluorescent light, a light emitting diode, or a combination thereof. The third driver circuit 1174 is coupled, for example, to a coil of a solenoid valve. The solenoid valve controls a mass transfer function such as, for example an air jet, a waterjet, or a saliva vacuum.

One of skill in the art will understand that a dental office may be an electrically noisy environment, especially when ultrasonic equipment is being used. One advantage of incorporating a microprocessor in the wireless transmitter, as shown in FIG. 17 and/or the wireless receiver as shown in FIG. 22 is it simplifies the transmission of more complex and complete information between the actuator device and the dental instrument being control. This allows, for example, error-checking and confirmation codes that prevent accidental activation of the dental tool in response to spurious radiofrequency or other signals.

The use of a microprocessor or microcontroller also allows automatic timing of tool activities, automatic adjustment of light levels, and other automatic features desirable to a dental professional. For example, it is possible to control various tools with a single foot pedal based on mutual communications between the foot pedal device and a sensor, such as a finger switch or capacitive sensor, in the tool indicating that it is presently being used.

The various receivers and transmitters discussed above have been presented as embodiments employing radiofrequency signals for communication. It will be understood by one of skill in the art, however, that other signaling means, including optical signaling and audio signaling (such as ultrasonic signaling) may be employed to good effect.

While this invention is described in detail with reference to a certain preferred embodiments, it should be appreciated that the present invention is not limited to those precise embodiments. Rather, in view of the present disclosure which describes the current best mode for practicing the invention, many modifications and variations would present themselves to those of skill in the art without departing from the scope and spirit of this invention.

What is claimed is:

1. A dental tool comprising:
a base unit comprising a signal receiver;
a handpiece having a proximal end and a distal end, said proximal end being coupled to an electrical energy source via a cable and said distal end having an insert extending therefrom; and
a wireless control switch comprising a corresponding signal transmitter; wherein said wireless control switch controls the operation of the dental tool by the transmission of a signal to the signal receiver.

2. The dental tool of claim 1 wherein the wireless control switch comprises an actuator such that a first signal is sent when the actuator is pressed and a second signal is sent when the actuator is released.

3. The dental tool of claim 2 wherein said first signal activates the dental tool and the second signal turns off the dental tool.

4. The dental tool of claim 1 wherein said wireless control switch is a manually operable element selected from the group consisting of a push button slide member and a control knob.

5. The dental tool of claim 1 wherein said wireless control switch is a foot switch.

6. The dental tool of claim 2 wherein said signal comprises a radio frequency or sonic frequency signal.

7. The dental tool of claim 1 wherein said wireless switch is battery-powered.

8. The dental tool of claim 2 wherein there is no electrical activity in the switch after the sending of the first signal.

9. The dental tool of claim 1 wherein said dental tool is selected from the group consisting of dental scaler tools, dental drills, rotary instruments and prophy angles.

10. The dental tool of claim 9 wherein said rotary instruments comprises endodontic files, reamers, multi-use diamond dental burs; dental carbide burs; dental sintered diamond burs; dental diamond discs; dental laboratory tungsten carbide cutters; dental steel burs; surgical drills; or prophy angles.

11. The dental tool of claim 9 wherein said wireless signal transmitter comprises a microprocessor for controlling the speed of the dental instruments.

12. The dental instrument of claim 7 wherein said battery is selectively coupled to a high frequency generator by means of a normally opened switch.

13. The dental tool of claim 11 wherein said opened switch is biased to the open positioned by a spring.

14. The dental tool of claim 1 wherein said wireless control switch comprises a tone generator or a constant frequency generator.

15. The dental instrument of claim 14 wherein said tone generator generates a constant frequency tone.

16. The dental instrument of claim 14 the signal generated by the constant frequency generator is in the audio range.

17. The dental tool of claim 14 wherein the signal generated by a constant frequency generator is converted into a sonic frequency by using a piezo-electric crystal element.

18. The dental tool of claim 1 wherein said signal receiver comprises a circuit for operating a bistable flip-flop for turning on/of the power source.

19. The dental tool of claim 9 wherein said insert comprises a transducer adapted to impart a vibration to the insert by a mode selected from the group consisting of mechanical, magnetostrictive and piezoelectric in nature.

20. The dental tool of claim 1 wherein said cable also couples to a fluid and/or gas source.

21. An ultrasonic dental tool comprising:
a base unit comprising a signal receiver;
a handpiece having a proximal end and a distal end, said proximal end being coupled to an electrical energy source and a fluid source via a cable and said distal end having an opening intended to receive an insert with a transducer extending from the proximal end of the insert for generating ultrasonic vibrations; and
a wireless control switch comprising a corresponding signal transmitter; wherein said wireless control switch controls the operation of the dental tool by the transmission of a signal to the signal receiver.

22. The ultrasonic dental tool of claim 21 wherein said wireless control switch comprises an actuator such that a first signal is sent when the actuator is pressed and a second signal is sent when the actuator is released.

23. The ultrasonic dental tool of claim 22 wherein said first signal activates the dental tool and the second signal turns off the dental tool.

24. The dental tool of claim 21 wherein said wireless control switch is a foot switch.

25. The dental tool of claim 21 wherein said signal comprises a radio frequency signal.

26. The dental tool of claim 22 wherein said wireless switch is battery-powered.

27. The dental tool of claim 22 wherein there is no electrical activity in the switch after the sending of the first signal.

28. The dental tool of claim 21 wherein said dental insert comprises an ultrasonic scaler.

29. The dental tool of claim 21 wherein said transducer is selected from a group consisting of magnetostrictive transducer, piezoelectric transducer and combinations thereof.

30. The dental tool of claim 21 further comprising
a second transducer disposed substantially proximate to the distal end of the insert for generating a voltage signal in response to movement of a portion of the handpiece according to the ultrasonic vibrations.

31. The dental tool of claim 30 wherein said second transducer comprises an illumination energy coil attached to at least one light source.

32. The dental tool of claim 31 wherein said light source being connected to and receiving the voltage signal from the second transducer to generate light.

33. A dental tool having an integrated light source comprising:
a base unit comprising a signal receiver;
a handpiece having a proximal end and a distal end, said proximal end being coupled to an electrical energy source via a cable and said distal end having an insert extending therefrom and ending in a tip section;
at least one light source substantially proximate to the tip section; and
a wireless control switch comprising a corresponding signal transmitter; wherein said wireless control switch controls the operation of the dental tool by the transmission of a signal to the signal receiver.

34. The dental tool of claim 33 wherein said wireless control switch comprises an actuator such that a first signal is sent when the actuator is pressed and a second signal is sent when the actuator is released.

35. The dental tool of claim 34 wherein said first signal activates the dental tool and the second signal turns off the dental tool.

36. The dental tool of claim 33 wherein said wireless control switch is a foot switch.

37. The dental tool of claim 33 wherein said wireless switch is battery-powered.

38. The dental tool of claim 33 wherein the operation of said light source is controlled by the same wireless switch that controls the other operations of the dental tool.

39. The dental tool of claim 33 wherein said light source is supplied by a separate power source.

40. The dental tool of claim 39 wherein the operation of said separate power source is controlled by the wireless control switch.

41. The dental tool of claim 33 wherein said cable also couples to a fluid and/or gas source.

42. A dental instrument comprising:
a handpiece including an electromechanical transducer and a control device coupled to said electromechanical transducer; and
means for transmitting a wireless control signal to said control device to control a function of said electromechanical transducer.

43. A dental instrument as defined in claim 42 wherein said means for transmitting a wireless control signal is selected from a group consisting of a radio frequency transmitter, a sonic transducer and a pulse generating device.

44. A dental instrument as defined in claim 43 wherein said pulse generating device is adapted to produce a communication pulse of short duration relative to an operating duration of said a dental instrument.

45. A dental instrument as defined in claim 42 wherein said means for transmitting a wireless control signal comprises:
a microprocessor, said microprocessor being adapted to produce an encoded communication signal for control of said dental instrument.

46. The dental instrument as defined in claim 45 wherein said means for transmitting a wireless control signal comprises:
means for receiving a further wireless signal, said further wireless signal being adapted to confirm error-free receipt of said wireless control signal by a dental instrument control device.
